(19) United States
(12) Patent Application Publication
(10) Pub. No.: US 2017/0100860 A1
(43) Pub. Date: Apr. 13, 2017

(54) FILLING MEMBER AND METHOD OF MANUFACTURING SEAT PAD USING THE FILLING MEMBER

(71) Applicant: BRIDGESTONE CORPORATION, Tokyo (JP)

(72) Inventor: Kenji KUMAGAI, Tokyo (JP)

(73) Assignee: BRIDGESTONE CORPORATION, Tokyo (JP)

(21) Appl. No.: 15/311,955

(22) PCT Filed: Apr. 16, 2015
(86) PCT No.: PCT/JP2015/061664

§ 371 Date: Nov. 17, 2016

(30) Foreign Application Priority Data
May 19, 2014 (JP) 2014-103069

(51) Int. Cl. B29C 44/12; B29C 45/14; B68G 7/06; B60N 2/70; A47C 7/74; B60N 2/56

(52) U.S. Cl. CPC B29C 44/1233; A47C 7/74; B60N 2/56; B68G 7/06; B60N 2/70; B29C 45/14065; B29K 2105/04

(57) ABSTRACT

A seat pad which can provide a favorable seating feeling while adhesion between a breathable member and a resin foam constituting the seat pad is ensured and a method of manufacturing such a seat pad are provided. A filling member including a breathable member having a ventilation function to an outside, used in a molding process of the seat pad for a vehicle integrally molded from a foam made of a foamable resin in a state where the breathable member is placed therein, and removed after the molding, is characterized by including a frame-shaped body attached to a peripheral side surface of an outside exposed surface of the breathable member and installed on a molding surface of a mold and a side-surface covering body installed upright on the frame-shaped body and partially covering a side surface of the breathable member.

### TECHNICAL FIELD

The present invention relates to a filling member and a method of manufacturing a seat pad using the filling member and particularly to a filling member used in a molding process of a seat pad for a vehicle including a breathable member having a ventilation function to an outside and a method of manufacturing a seat pad using the filling member.

### BACKGROUND ART

A seat pad used for a vehicle seat and the like includes a back pad for supporting the back of a passenger and a cushion pad for supporting the buttocks of the passenger in general and is molded from a soft polyurethane foam obtained by foaming a foamable resin material or a resin foam such as semi-hard polyurethane foam or the like.

In this type of seat pad, in order to ensure breathing of the seat pad and to promote temperature control, humidity control and the like, a technology of forming an opening or a breathing portion made of a predetermined material in the resin foam is known. For example, in Patent Literature 1 by the present applicant, a seat pad in which the breathable member having a ventilation function to an outside is formed by a resin foam subjected to film-removing processing and which is integrally foamed/molded from the foamable resin material including this breathable member is proposed.

### PRIOR ART LITERATURE

### Patent Literature

[Patent Literature 1] Japanese Patent Laid-Open No. 2006-42985

### SUMMARY OF INVENTION

### Problems to be Solved by the Invention

However, if the liquid-state foamable resin material is poured into a mold in a state where the breathable member is arranged in the mold, the foamable resin material penetrates into the breathable member in a low viscosity state before foaming or during foaming, and if the foamable resin material is foamed in the penetrating state, the foamable resin material having penetrated into the breathable member would be cured without being sufficiently foamed.

In this case, the cured breathable member into which the foamable resin material has penetrated is formed hard with a density higher than that of the resin foam generated with the appropriately foamable resin material and thus, it affects a seating feeling of a product seat using the resin foam.

The present invention has been made in view of the aforementioned problem and has an object to provide a filling member which can ensure adhesion between the breathable member and the resin foam after foaming and is used in a molding process of the seat pad which provides a favorable seating feeling and a method of manufacturing the seat pad using the filling member.

### Means for Solving the Problems

In order to solve the aforementioned problem, a filling member according to an invention described in claim 1 including a breathable member having a ventilation function to an outside, used in a molding process of a seat pad for a vehicle integrally molded from a foam made of a foamable resin in a state where the breathable member is placed therein, and removed after the molding, is characterized by including a frame-shaped body attached to a peripheral side surface of an outside exposed surface of the breathable member and installed on a molding surface of a mold and a side-surface covering body installed upright on the frame-shaped body and partially covering a side surface of the breathable member.

According to this configuration, by means of the side-surface covering body installed upright on the frame-shaped body installed on the molding surface of the mold, the foamable resin material penetrating into an inside from the side surface of the breathable member can be shut off, and the penetration of the foamable resin material into the breathable member occurs only on the side-peripheral surface portion of the breathable member not covered by the side-surface covering body. That is, since the breathable member is partially impregnated with the foaming material, excessive penetration of the foamable resin material into the breathable member is prevented, while a certain adhesion effect between the foam made of the foamable resin and the breathable member is ensured after the foaming, and as a result, the seating feeling of the product seat manufactured by using the seat pad which is a molded product can be improved.

An invention described in claim 2 is characterized in that, in the filling member described in claim 1, the side-surface covering body is constituted as partially standing bodies installed upright on the frame-shaped body at a predetermined interval in a peripheral direction of the frame-shaped body.

According to this configuration, on the side-surface of the breathing member covered by the partially standing bodies installed upright at the predetermined interval in the peripheral direction, the foamable resin material does not penetrate into the breathable member, while on the side-surface the breathing member not covered by the partially standing body, the penetration of the foamable resin material into the breathable member is allowed. That is, partial shut-off of the foamable resin material can be realized by a simple configuration in which the partial standing bodies are provided at the predetermined interval on the frame-shaped body.

An invention described in claim 3 is characterized in that, in the filling member described in claim 2, a holding frame body for holding each of tip end portions of the partially standing bodies in the standing direction to collect them on a side of the breathable member is provided in the side-surface covering body.

According to this configuration, since the partially standing body is urged toward the side surface of the breathable member, generation of a gap between the partially standing body and the side surface of the breathable member can be prevented, and as a result, penetration of the foamable resin material through the portion of the side surface of the breathable member where the penetration of the foamable resin material should be shut off can be prevented.

An invention described in claim 4 is characterized in that, in the filling member described in claim 2 or 3, the partially standing bodies are arranged over the entire region in the circumferential direction of the frame-shaped body at a predetermined interval and each have a substantially rectangular shape.

According to this configuration, a portion where the aforementioned penetration of the foamable resin material into the breathable member is prevented appears as the substantially rectangular region at predetermined interval along the circumferential direction on the side surface of the breathable member. Therefore, the portion of the side surface of the breathable member where the aforementioned penetration of the foamable resin material is prevented and the portion of the side surface of the breathable member allowing the penetration of the foamable resin material alternately appear equally over the entire region in the circumferential direction of the side-surface region of the breathable member and over a certain range, whereby an adhesion state between the breathable member and the resin foam in the molded seat pad is made extremely favorable.

An invention described in claim 5 is characterized in that, in the filling member described in claim 2 or 3, each of the partially standing bodies has a tapered plate shape whose width is narrowed from a base end toward a tip end in a standing direction.

According to this configuration, in the base-end side region on the circumferential surface of the breathable member where excessive penetration of the foamable resin material can easily occur since the foamable resin material is in a state immersed in the liquid-state foamable resin material after the liquid-state foamable resin material is poured into the mold and before it is foamed, the penetration of the foamable resin material can be completely shut off, while in the tip-end side region on the side circumferential surface of the breathable member where a penetration tendency of the foamable resin material is considered to be lower than that on the base-end side region on the circumferential surface of the breathable member since it is not in a state immersed in the foamable resin material in the state at least before being foamed, a relatively large region where the foamable resin material can penetrate can be formed. Therefore, the resin impregnation amount to the entire breathable member can be preferably controlled as a result, and a favorable adhesion state between the breathable member and the resin foam after being foamed can be obtained.

Moreover, in order to solve the aforementioned problem, a method of manufacturing a seat pad according to an invention described in claim 6 is a method of manufacturing a seat pad using the filling member described in any one of claims 1 to 5 and is characterized by including a step of loading the filling member in the breathable member, a step of arranging the filling member loaded with the breathable member on a molding surface of a mold, a step of molding the seat pad by supplying a foamable resin material into the mold after the arrangement and by heating the foamable resin material so as to foam, and a step of removing the filling member from the molded seat pad.

According to the present invention, since the seat pad is manufactured by using the filling member, the seat pad which provides a favorable seating feeling of a product seat can be obtained while adhesion between the breathable member and the resin foam is ensured after being foamed.

### Effects of Invention

According to the present invention, by means of the side-surface covering body installed upright on the frame-shaped body installed on the molding surface of the mold, the foamable resin material penetrating into the inside from the side surface of the breathable member can be shut off, and the penetration of the foamable resin material into the breathable member occurs only on the side-peripheral surface portion of the breathable member not covered by the side-surface covering body. That is, since the breathable member is partially impregnated with the foamed material, the excessive penetration of the foamable resin material into the breathable member can be prevented while a certain adhesion effect between the resin foam and the breathable member is ensured after the foaming, and the seating feeling of the product seat manufactured by using the seat pad which is the molded product can be improved as a result. That is, by using the filling member according to the present embodiment, the impregnation amount of the foamable resin material into the breathable member can be preferably controlled and the product seat with a favorable quality can be obtained as a result.

### BRIEF DESCRIPTION OF DRAWINGS

FIG. 1 is a view illustrating a schematic configuration of a seat for vehicle including a seat pad manufactured by using a filling member according to an embodiment of the present invention.

FIG. 2 is a view for explaining a configuration of the filling member according to the embodiment of the present invention.

FIG. 3 is a view for explaining a configuration in which the breathable member is loaded in the filling member.

FIG. 4 is a view for explaining the configuration of the filling member in a state where a holding frame body is mounted.

FIG. 5 is a view for explaining an outline of a method of manufacturing the seat pad according to the present embodiment.

FIG. 6 is an A-A line sectional view of FIG. 1.

FIG. 7 is an enlarged view of a B part of FIG. 1.

FIG. 8 is a view for explaining a variation of the configuration of the filling member.

FIG. 9 is a view for explaining a variation of the configuration of the filling member.

### MODE FOR CARRYING OUT THE INVENTION

Subsequently, an embodiment of the present invention will be described in detail on the basis of the attached drawings. In the present embodiment, an example in which a seat pad is used as a seat for vehicle is explained.

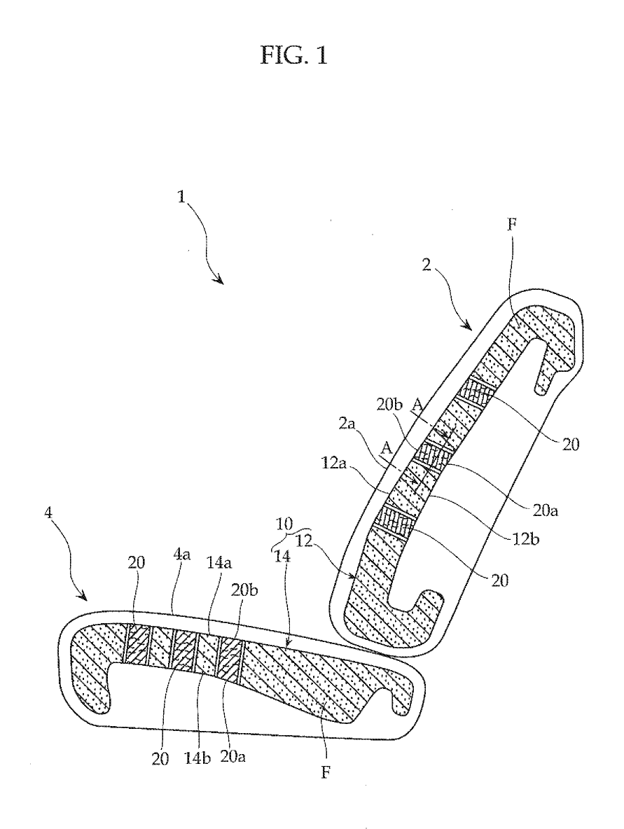

FIG. 1 is a view for explaining an outline of the seat pad used for a seat according to the present embodiment. As illustrated, the seat 1 includes a seat back portion 2 for supporting the back part of a passenger and a seat cushion portion 4 for supporting the buttocks of the passenger.

The seat pad 10 of the present embodiment is used for such seat 1 and is formed by using a resin foam F obtained by foaming a foamable resin material as the major constituent material.

This seat pad 10 includes a back pad 12 covered by a skin 2a such as woven knitting or the like with favorable breathability and constituting the seat back portion 2 and a cushion pad 14 covered by a skin 4a such as woven knitting with favorable breathability and constituting the seat cushion portion 4.

The seat pad 10 includes a substantially columnar breathable member 20 made of a fibrous material with favorable breathability in the present embodiment. The breathable member 20 is made of the fibrous material with favorable breathability and is formed having a substantially columnar shape having an upper end surface 20a and a lower end surface 20b constituting outside exposure surfaces and a side peripheral surface 20c connecting the upper end surface 20a and the lower end surface 20b. As a result, a surface 12a side and a back surface 12b side of the back pad 12 communicate with each other through the breathable member 20, and breathing state of the back pad 12 is ensured.

In the periphery of this breathable member 20, by molding the seat pad 10 by using a filling member 40 according to the present embodiment which will be described later in detail, hollow regions 21 into which a foamable resin material does not penetrate are formed at a predetermined interval in a circumferential direction on the side surface thereof.

In this seat pad 10, by exposing the upper end surface 20a and the lower end surface 20b of the breathable member 20 made of the fibrous material to an outside of the seat pad 10, the surface 12a side and the back surface 12b side of the back pad 12 communicate with each other through the breathable member 20 included in the back pad 12, and a seat surface 14a side and a back surface 14b side of the cushion pad 14 communicate with each other through the breathable member 20 included in the cushion pad 14.

As a result, the breathing state between the seat pad 10 and the outside of the seat pad 10 is ensured, and heat or humidity absorbed by the seat pad 10 is discharged to the outside through the breathable member 20, whereby temperature control and humidity control of the seat pad 10 is promoted.

Subsequently, a specific configuration of the filling member 40 according to the present embodiment will be described.

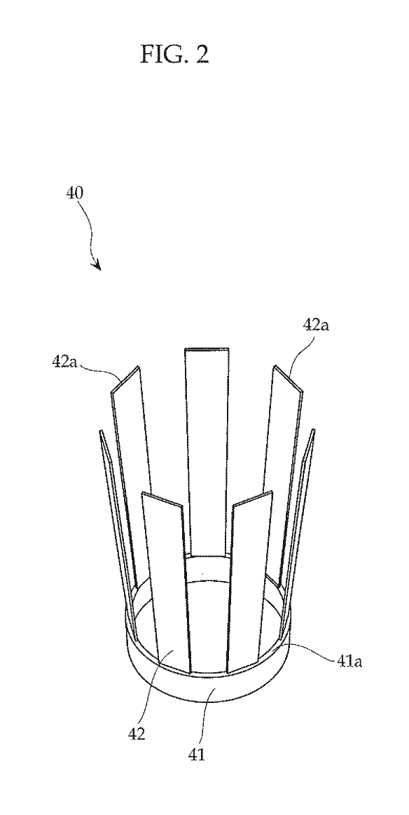

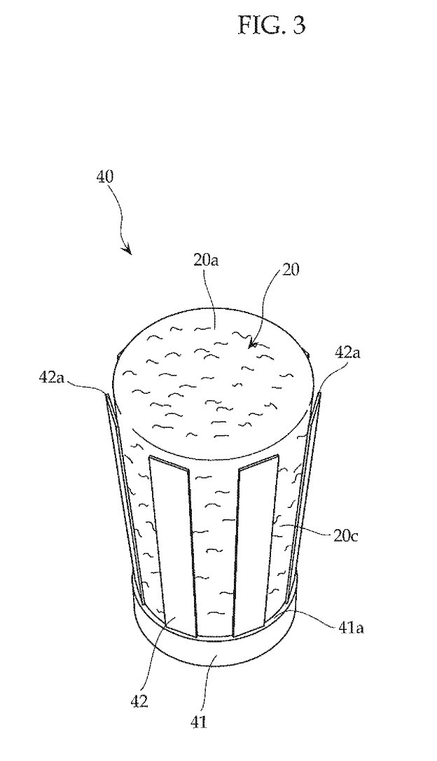

FIG. 2 is a view for explaining the configuration of the filling member 40 according to the present embodiment, and FIG. 3 is a view illustrating a state where the breathable member 20 is provided in the filling member 40. As illustrated, the filling member 40 has a ring-shaped portion 41 which is a frame-shaped body installed on a molding surface of a mold and a standing plate 42 installed upright on an upper surface 41a of this ring-shaped portion 41. The ring-shaped portion 41 is formed of a material into which the resin material does not penetrate such as a metal material such as aluminum.

The standing plates 42 are bonded to the upper surface 41a of the ring-shaped portion 41 by using various bonding methods including welding and the like that could be conceived of by those skilled in the art and are arranged at a plurality of spots (eight spots in the figure) at a certain interval along the circumferential direction of the ring-shaped portion 41. Particularly, in the present embodiment, the standing plate 42 is formed having a substantially rectangular shape.

Therefore, in the filling member 40 according to the present embodiment, in the state where the breathable member 20 is loaded, a peripheral side surface of the lower end surface 20b of the breathable member 20 is covered by the ring-shaped portion 41, and the side peripheral surface 20c of the breathable member 20 is partially covered by the standing plate 42.

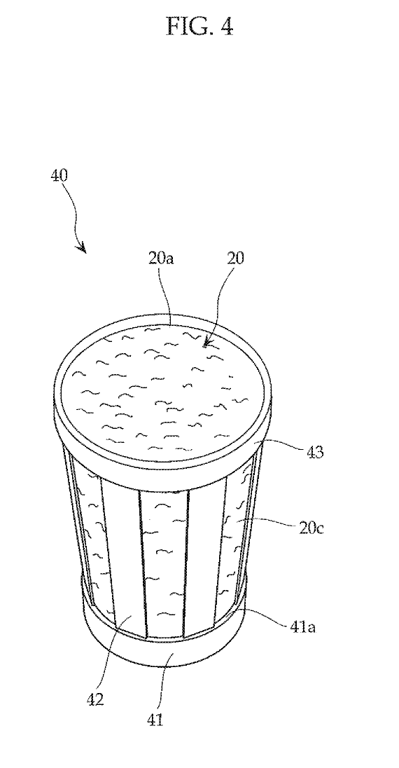

FIG. 4 is a view for explaining a state where a holding frame body is mounted on the filling member 40 in which the breathable member 20 is loaded. As illustrated, on the filling member 40 in which the breathable member 20 is loaded, an upper ring 43 is provided as the holding frame body for holding each of tip end portions 42a of the plurality of standing plates 42 in the standing direction so that they are gathered to the breathable member 20 side. As a result, close contact (covering performances) of the standing plates 42 to the side peripheral surface 20c of the breathable member 20 is improved.

Though not shown, bonding between the upper ring 43 and the tip end portions 42a of the standing plates 42 can be accomplished in a bonding form capable of easy attachment/removal such as fitting, considering removal of the upper ring 43 together with the seat pad from the tip end portions 42a when the seat pad is released.

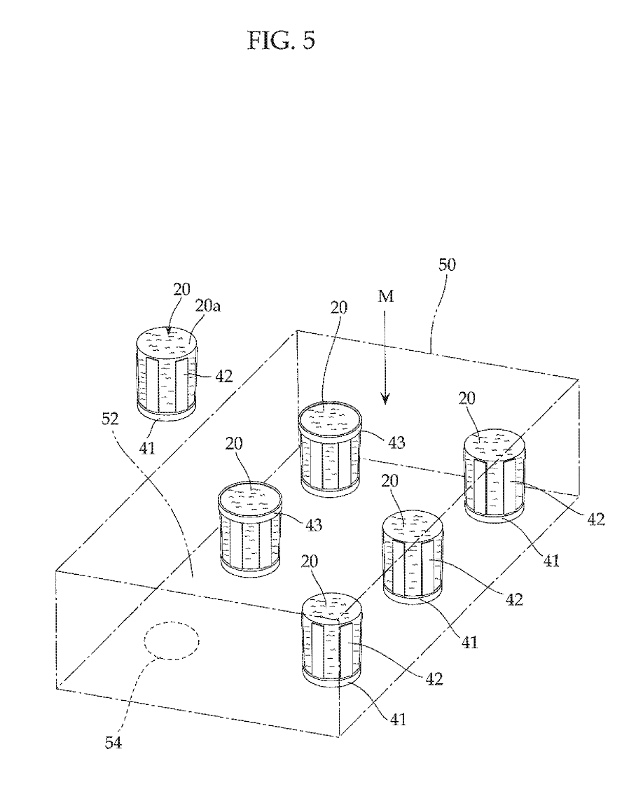

FIG. 5 is a view for explaining an outline of a method of manufacturing the seat pad 10 according to the present embodiment.

As illustrated, in the present embodiment, first, the ring-shaped portion 41 and the standing plates 42 integrated with the ring-shaped portion 41 are loaded with the breathable member 20 (the state in FIG. 3), and arranged on the molding surface 52 in the lower die cavity 50 of a virtual mold indicated by a two-dot chain line. On the molding surface 52, positioning marks 54 are provided in the seat pad 10 at positions corresponding to the positions where the breathable members 20 are arranged where the breathable members 20 are arranged on the molding surface 52.

Then, the six breathable members 20 are arranged and positioned on the molding surface 52 with portions of the ring-shaped portions 41 of the filling members 40 loaded with the breathable members 20 matched with the marks 54, the upper rings 43 are attached to them, and an upper die and a core die, not shown, are moved with respect to a lower die cavity 50 in a mold closing direction and closed.

In the present embodiment, when the upper die and the core die are moved in the mold closing direction and closed, the molding surface of the core die is brought into contact with the upper end surface 20a of the breathable member 20. That is, the molding surface of the core die and the molding surface 52 of a lower die cavity 50 continue to each other through the breathable member 20.

After the mold is closed, a liquid-state foamable resin material M is poured into the mold toward the molding surface 52. A spout of the foamable resin material M is set at a position where the foamable resin material M is not directly fallen toward the breathable members 20 arranged on the lower die cavity 50, that is, the positions where they are not in direct contact with the breathable members 20 in the present embodiment.

The liquid-state foamable resin material M with low viscosity filled in the mold flows on the molding surface 52 of the lower die cavity 50. However, in the present embodiment, by means of the ring-shaped portion 41 of the filling member 40, penetration of the foamable resin material M into the breathable member 20 through a slight gap between the molding surface 52 and the lower end surface 20b of the breathable member 20 is prevented. Moreover, even in a state where the foamable resin material M has been poured and stored up to a certain height in the mold, the penetration of the foamable resin material M is shut off in the portion where the standing plates 42 installed upright on the ring-shaped portion 41 cover the side peripheral surface 20c.

On the other hand, the penetration of the foamable resin material M is allowed in the portion not covered by the standing plates 42.

Then, the mold is heated, and the foamable resin material M filled in the mold is foamed. In the present embodiment, the foamable resin material M penetrates through the portion of the side peripheral surface 20c not covered by the standing plates 42 in the breathable member 20 as the foaming progresses, and the foamable resin material M is cured in that state. On the other hand, in the portion covered by the standing plates 42 in the side peripheral surface 20c of the breathable member 20, the foamable resin material M does not penetrate but is foamed where it is.

When the foaming of the foamable resin material M is finished in this state, the resin foam F is generated, and the back pad 12 or the cushion pad 14 in the seat pad 10 containing the breathable member 20 is integrally molded.

After the seat pad 10 is molded, the upper die and the core die are moved in a mold opening direction and the mold is opened, and the molded seat pad 10 is released from the lower die cavity 50. Here, in the present embodiment, when the seat pad 10 is released from the lower die cavity 50, the ring-shaped portion 41 is made to remain in a state where the ring-shaped portion 41 adheres to the lower die cavity 50 by the heating of the mold, and the ring-shaped portion 41 and the standing plates 42 integral with the ring-shaped portion 41 are removed from the seat pad 10. At this time, the upper ring 43 is removed from the standing plates 42 and taken out of the mold in a state still attached to the peripheral side surface of the upper end surface 20a of the breathable member 20 exposed to the other surface of the seat pad 10.

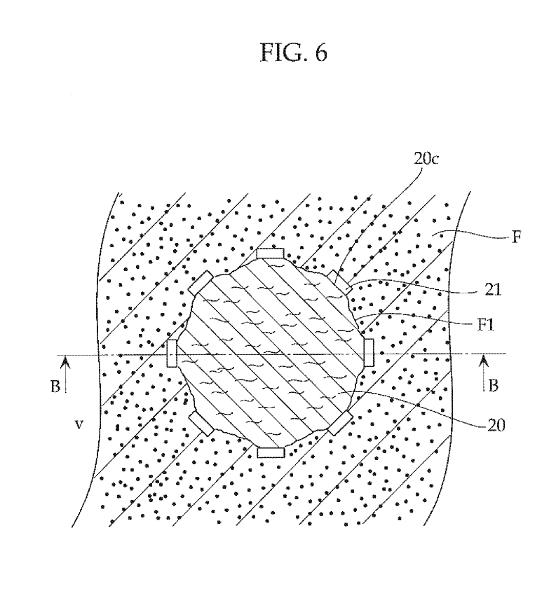

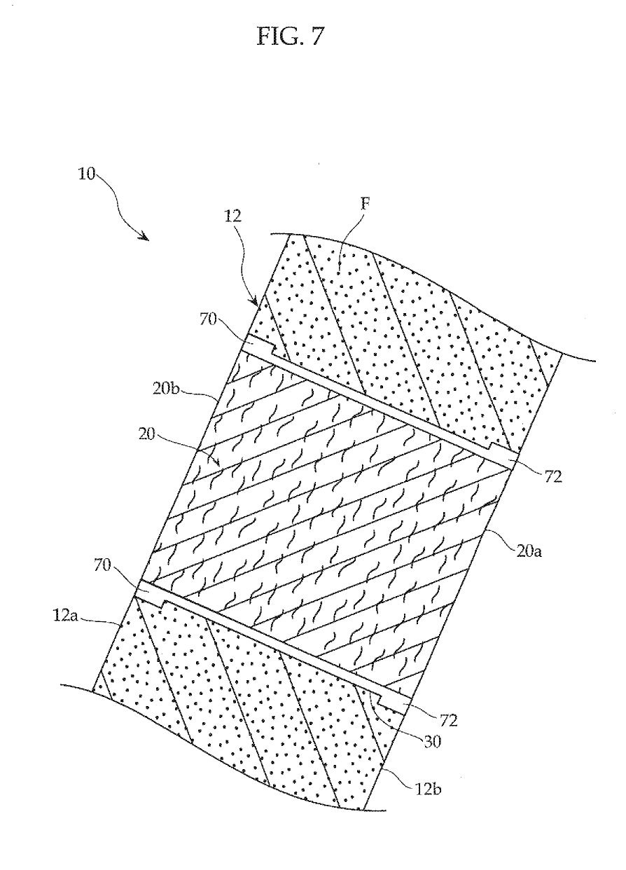

FIG. 6 is an A-A line sectional view of FIG. 1 illustrating an outline of the foamed/molded seat pad 10, and FIG. 7 is a B-B line sectional view of FIG. 6. As illustrated, in the side peripheral surface 20c of the breathable member 20, the portion covered by the standing plates 42 of the filling member 40 has the hollow regions 21 formed, and the foamable resin material M does not penetrate into the breathable member 20.

On the other hand, it is understood that, in the portion of the side peripheral surface 20c not covered by the standing plates 42 of the filling member 40, the resin material F penetrates, is cured and forms a cured portion F1. As is obvious from the figure, this cured portion F1 is formed at eight spots at substantially equal intervals along the side peripheral surface 20c of the breathable member 20, corresponding to the arrangement positions of the standing plates 42 provided on the upper surface 41a of the ring-shaped portion 41 in the filling member 40.

Therefore, the hollow regions 21 and the cured portions F1 are present alternately in the circumferential direction of the breathable member 20, corresponding to the positions of the portions covered by the standing plates 42 and the positions of the portions not covered, respectively.

Moreover, in the portion of the side peripheral surface 20c around the lower end surface 20b of the breathable member 20 in a portion where the ring-shaped portion 41 is removed, an annular groove portion 70 following the ring-shaped portion 41 is formed. Furthermore, in the portion of the side peripheral surface 20c around the upper end surface 20a of the breathable member 20 in a portion where the upper ring 43 is removed, an annular groove portion 72 following the upper ring 43 is formed. The groove portion 70 and the groove portion 72 are formed on the whole area of the breathable member 20 in the circumferential direction.

As a result, by means of the presence of the portion of the hollow region 21 where the cured portion F1 is not formed, flexibility of the breathable member 20 and its periphery is ensured, excessive penetration of the foamable resin material F into the breathable member 20 is prevented while the certain adhesion effect between the resin foam F and the breathable member 20 is ensured after the foaming, and the seating feeling on the seat manufactured by using the seat pad 10 which is the molded product can be improved as a result. That is, by using the filling member 40 according to the present embodiment, the entire impregnation amount of the foamable resin material F into the breathable member 20 can be favorably adjusted, and a product seat with a favorable quality can be obtained as a result.

Particularly, in the present embodiment, with the simple configuration in which the standing plates 42 are installed upright at certain intervals on the ring-shaped portion 41, the portion where the penetration of the foamable resin material M into the breathable member 20 is prevented appears as a substantially rectangular region equally and in a certain range along the circumferential direction on the side peripheral surface 20c of the breathable member 20. As a result, the aforementioned portion of the side peripheral surface 20c of the breathable member 20 preventing the penetration of the foamable resin material M and the portion of the side peripheral surface 20c of the breathable member allowing the penetration of the foamable resin material M alternately appear over the entire region in the circumferential direction, and the adhesion state between the breathable member 20 and the resin foam F in the seat pad becomes extremely favorable after the molding.

Moreover, since the upper ring 43 as the holding frame body is provided at each of the tip end portions 42a of the standing plates 42 in the filling member 40 in which the breathable member 20 is loaded, the standing bodies 42 are urged toward the side peripheral surface 20c of the breathable member 20 and thus, generation of a gap between the standing plates 42 and the side peripheral surface 20c of the breathable member 20 can be prevented, and as a result, the penetration of the foamable resin material M into this portion can be prevented.

The aforementioned cured portion F1, the hollow region 21, and the groove portions 70 and 72 are formed only in an extremely small range compared with the size of the back pad 12 or the cushion pad 14 of the seat pad 10, and they do not affect seating properties of the seat pad 10.

Subsequently, a variation of a filling member 60 according to the present embodiment will be described.

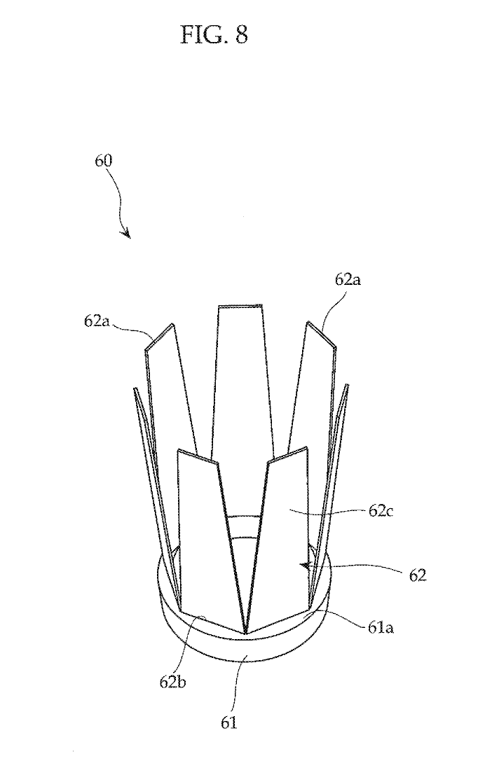

FIG. 8 is a view for explaining a configuration of the filling member 60 according to the variation. As illustrated, the filling member 60 according to this variation has a ring-shaped portion 61 installed on the molding surface 52 of the mold and standing plates 62 installed upright on an upper surface 61a of this ring-shaped portion 61. The ring-shaped portion 61 has a configuration substantially similar to the aforementioned ring-shaped portion 41. The standing plates 62 are arranged at a plurality of spots (seven spots in the figure) over the entire region in the circumferential direction of an upper surface 61a of the ring-shaped portion 61. Each of the standing plates 62 has a tapered plate shape whose width is narrowed from a base end portion 62b toward a tip end portion 62a in the upper surface 61a portion of the ring-shaped portion 41. The standing plate 62 is bonded to the upper surface 61a of the ring-shaped portion 61 by using various bonding methods including welding and the like that could be conceived of by those skilled in the art similarly to the aforementioned standing plates 42.

Moreover, the base end portion 62b of each standing plate 62 extends over a certain length in the substantially circumferential direction of the ring-shaped portion 61 and the base end portions 62b of the standing plates 62 adjacent in the circumferential direction are in contact with each other on the end portions in the circumferential direction. Therefore, the entirety of all the base end portions 62b of the standing plates 62 at the seven spots cover the whole region in the circumferential direction in the ring-shaped portion 61.

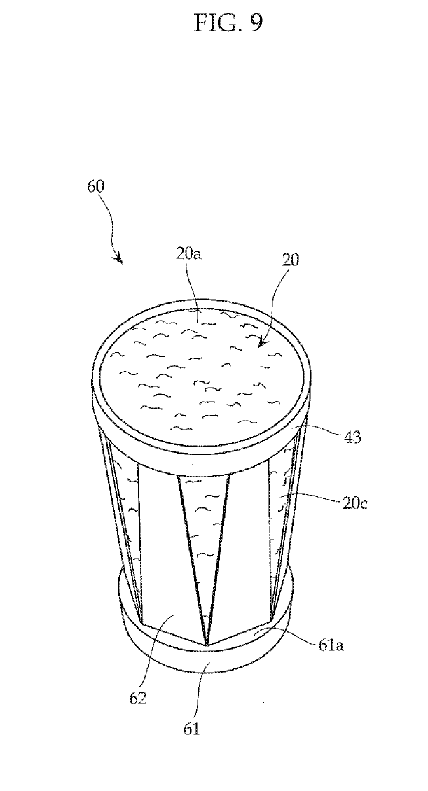

FIG. 9 illustrates a state where the fibrous breathable member 20 is provided to the ring-shaped portion 61 according to the variation and the standing plates 62 integrated with the ring-shaped portion 61 and moreover, an upper ring 63 is mounted on the standing plates 62. A function of the upper ring 63 and a mounted mode to the standing plates 62 are similar to the case of the aforementioned upper ring 43.

As illustrated, according to the filling member 60 according to this variation, similarly to the case of the aforementioned filling member 40, the peripheral side surface of the lower end surface 20b of the breathable member 20 is covered by the ring-shaped portion 61, and the portion prevents penetration of the foamable resin material M.

Moreover, the standing plates 62 cover a part of the regions of the side peripheral surface 20c of the breathable member 20, and the portion prevents the penetration of the foamable resin material M, but particularly in this variation, since the standing plate 62 has the shape which is gradually tapered from the base end portion 62b toward the tip end portion 62a, that is, the shape in which an area of the covered side surface 62c gradually decreases toward the tip end portion 62a, the region of the portion not covered by the standing plates 62 in the side peripheral surface 20c of the breathable member 20 becomes larger as it goes in the direction toward the upper end surface 20a from the lower end surface 20b of the breathable member 20.

Therefore, regarding the foamable resin material M having been poured into the mold, the penetration into the breathable member 20 is completely shut off in the side peripheral surface 20c region in the periphery of the lower end surface 20b of the breathable member 20, that is, in the periphery of the portion to which the ring-shaped portion 61 is attached, while the portion not covered by the standing plates 62 increases as it goes toward the side peripheral surface 20c region in the periphery of the upper end surface 20a of the breathable member 20, and the region allowing the penetration of the foamable resin material M increases.

According to this configuration, after the liquid-state foamed rein material M is poured into the mold and before it is foamed, in the side peripheral surface 20c region in the periphery of the lower end surface 20b of the breathable member 20 in a state impregnated with the foamable resin material M where the foamable resin material M can easily penetrate, the penetration of the foamable resin material M is completely shut off.

On the other hand, in the side peripheral surface 20c region in the periphery of the upper end surface 20a of the breathable member 20, immediately after the resin material M is poured, a height of the foamable resin material M does not reach the region, and the state impregnated with the foamable resin material M is not realized at least before foaming. Therefore, the region is considered to have a low penetration tendency of the foamable resin material M as compared with the side peripheral surface 20c region in the periphery of the lower end surface 20b of the breathable member 20. In the present embodiment, in the portion with the low penetration tendency of the foamable resin material M, an area allowing the penetration of the foamable resin material M is intentionally taken larger.

Therefore, the impregnation amount of the breathable member 20 with the foamable resin material M can be preferably adjusted, and the favorable adhesion state can be obtained between the breathable member 20 and the resin foam F after the foaming.

The present invention is not limited to the aforementioned embodiment but is capable of various changes within a range not departing from the gist of the invention. For example, in the molding using the filling member 40 in the aforementioned embodiment, the breathable member 20 is loaded in the ring-shaped portion 41, but the present invention is not limited to this, and it may be so configured that the ring-shaped portion 41 is arranged on the molding surface 52 of the mold, first, and then, the breathable member 20 is loaded in the ring-shaped portion 41. Attachment of the upper ring 43 to the standing plates 42 may be performed either before or after the ring-shaped portion 41 is arranged on the molding surface 52 as long as it is after the breathable member 20 is provided to the ring-shaped portion 41.

Moreover, in the cushion pad 14 of the seat pad 10, instead of the columnar breathable member 20, a breathable member formed having a block shape so as to be brought into contact with the buttocks to the femoral region of the passenger can be also used. In this case, the shapes of the ring-shaped portion 41, the standing plates 42, and the upper ring 43 can be changed as appropriate so as to be adapted to the shape of the block-shaped breathable member.

Moreover, in the aforementioned embodiment, the case in which the seat 1 in which the seat pad 10 is used is a seat for vehicle is described, but it can be used for various seats for railway vehicles, aircrafts, ships and the like, for example.

### REFERENCE SIGNS LIST

1 seat
10 seat pad
12 back pad
14 cushion pad
20 breathable member
20a upper surface (end surface)
20b lower surface (end surface)
20c side peripheral surface
40 filling member
41 ring-shaped member (frame-shaped body)
42 standing plate (side-surface covering body)
43 upper ring (holding frame body)
50 lower die cavity
52 molding surface
F resin foam
F1 cured portion
M foamable resin material

1. A filling member for a molding process of a seat pad, comprising:
a frame-shaped body attached to a peripheral side surface of an outside exposed surface of a breathable member of the seat pad and installed on a molding surface of a mold; and
a side-surface covering body installed upright on the frame-shaped body and partially covering a side surface of the breathable member.

2. The filling member according to claim 1, wherein
the side-surface covering body is constituted as partially standing bodies installed upright on the frame-shaped body at a predetermined interval in a peripheral direction of the frame-shaped body.

3. The filling member according to claim 2, wherein
in the side-surface covering body, a holding frame body for holding each of tip end portions of the partially standing bodies in the standing direction to collect them on a side of the breathable member is provided.

4. The filling member according to claim 2, wherein
the partially standing bodies are arranged over an entire region in a circumferential direction of the frame-shaped body at a predetermined interval and each have a substantially rectangular shape.

5. The filling member according to claim 2, wherein
each of the partially standing bodies has a tapered plate shape whose width is narrowed from a base end toward a tip end in a standing direction.

6. A method of manufacturing a seat pad, comprising:
a filling member providing step of providing the filling member in a mold, wherein the filling member comprising a frame-shaped body attached to a peripheral side surface of an outside exposed surface of a breathable member and installed on a molding surface of a mold; and
a side-surface covering body installed upright on the frame-shaped body and partially covering a side surface of the breathable member,
a foaming/molding step of foaming/molding the seat pad by supplying and foaming a foamable resin material into the mold in a state where the filling member loaded with the breathable member is arranged on a molding surface of the mold; and
a filling member removing step of removing the filling member from the molded seat pad.

7. A method of manufacturing a seat pad according to claim 6, comprising;
a filling member providing step of providing the filling member in a mold, wherein the side-surface covering body is constituted as partially standing bodies installed upright on the frame-shaped body at a predetermined interval in a peripheral direction of the frame-shaped body,
a foaming/molding step of foaming/molding the seat pad by supplying and foaming a foamable resin material into the mold in a state where the filling member loaded with the breathable member is arranged on a molding surface of the mold; and
a filling member removing step of removing the filling member from the molded seat pad.

8. A method of manufacturing a seat pad according to claim 6, comprising;
a filling member providing step of providing the filling member in a mold,
wherein in the side-surface covering body, a holding frame body for holding each of tip end portions of the partially standing bodies in the standing direction to collect them on a side of the breathable member is provided,
a foaming/molding step of foaming/molding the seat pad by supplying and foaming a foamable resin material into the mold in a state where the filling member loaded with the breathable member is arranged on a molding surface of the mold; and
a filling member removing step of removing the filling member from the molded seat pad.

9. A method of manufacturing a seat pad according to claim 6, comprising;
a filling member providing step of providing the filling member in a mold,
wherein the partially standing bodies are arranged over an entire region in a circumferential direction of the frame-shaped body at a predetermined interval and each have a substantially rectangular shape,
a foaming/molding step of foaming/molding the seat pad by supplying and foaming a foamable resin material into the mold in a state where the filling member loaded with the breathable member is arranged on a molding surface of the mold; and
a filling member removing step of removing the filling member from the molded seat pad.

10. A method of manufacturing a seat pad according to claim 6, comprising;
a filling member providing step of providing the filling member in a mold,
wherein each of the partially standing bodies has a tapered plate shape whose width is narrowed from a base end toward a tip end in a standing direction,
a foaming/molding step of foaming/molding the seat pad by supplying and foaming a foamable resin material into the mold in a state where the filling member loaded with the breathable member is arranged on a molding surface of the mold; and
a filling member removing step of removing the filling member from the molded seat pad.
